(19) United States
(12) Patent Application Publication
(10) Pub. No.: US 2023/0167054 A1
(43) Pub. Date: Jun. 1, 2023

(54) DI-SEC-BUTYL PEROXYDICARBONATE EMULSION

(71) Applicant: ARKEMA FRANCE, Colombes (FR)

(72) Inventors: Markus BRANDHORST, PIERRE-BENITE CEDEX (FR); Jacques COCHET, PIERRE-BENITE CEDEX (FR); Isabelle TARTARIN, VENETTE (FR)

(21) Appl. No.: 17/997,744

(22) PCT Filed: May 20, 2021
(86) PCT No.: PCT/FR2021/050928

§ 371 Date: Nov. 2, 2022

(30) Foreign Application Priority Data
May 20, 2020 (FR) FR2005281
May 20, 2020 (FR) FR2005306
May 20, 2020 (FR) FR2005309

(51) Int. Cl. C07C 409/38; C07C 407/00; C08K 5/14; C08F 2/30; C08F 214/06

(52) U.S. Cl. CPC C07C 409/38; C07C 407/006; C08K 5/14; C08F 2/30; C08F 214/06

(57) ABSTRACT

The invention relates to an organic peroxide emulsion comprising at least one organic peroxide comprising di-sec-butyl peroxydicarbonate, at least one emulsifier, at least one antifreeze, and water; said emulsion being free of methanol and ethanol.

The invention also relates to a process for preparing such an emulsion, to the use of such an emulsion for the polymerization or copolymerization of one or more ethylenically unsaturated monomers, and also to a halogenated vinyl polymer obtained by using such an emulsion.

### FIELD OF THE INVENTION

The present invention relates to a di-sec-butyl peroxydicarbonate emulsion free of methanol and ethanol, to a process for preparing same and to the use thereof for the polymerization or copolymerization of one or more ethylenically unsaturated monomers. The invention also relates to a halogenated vinyl polymer prepared in the presence of such an emulsion.

### TECHNICAL BACKGROUND

Organic peroxides, in liquid or solid form, are commonly used as polymerization initiators for ethylenically unsaturated monomers for the synthesis of various types of polymers.

However, their use frequently presents a certain number of problems. Specifically, organic peroxides usually constitute highly unstable species since they decompose relatively easily under the action of a slight input of heat, of mechanical energy (friction or impact) or of incompatible contaminants. Thus, in the event of an uncontrolled elevation of their storage temperature, certain organic peroxides can undergo an autoaccelerated exothermic decomposition which can result in fires and/or violent explosions. In addition, under these conditions, some of these organic peroxides can release combustible vapors that are capable of reacting with any source of ignition which can drastically increase, or even accelerate, the risks of violent explosion. As a result, it is important to take appropriate precautionary measures in terms of safety during the storage and transportation of organic peroxides.

In order to overcome these drawbacks, organic peroxides are notably packaged in the form of aqueous emulsions comprising antifreezes. Thus, the presence of water makes it possible both to absorb and to dissipate the energy generated in the event of exothermic decompositions of organic peroxides, while the role of the antifreeze is to keep the emulsion in liquid form, at temperatures of less than −10° C., generally of less than −15° C., which makes it possible to limit the risks of an involuntary exothermic decomposition of organic peroxides.

The aqueous emulsions generally also contain an emulsifier having the advantage of lowering the interfacial tension between the aqueous phase and the organic peroxide for the purpose of facilitating the dispersion of the peroxide in the form of droplets and of maintaining the size of said droplets over time. Specifically, over time, the peroxide droplets may sediment, form a cream, or undergo Ostwald ripening, or may agglomerate together, bringing about an increase in their mean size and in their maximum size which can result, in certain cases, in total or partial phase separation and consequently in an overall destabilization of the emulsion.

In view of the above, aqueous organic peroxide emulsions must therefore be stable for safety reasons not only during their production but also for a relatively long period of time during their transportation and storage before being used as polymerization initiators. For this purpose, as mentioned above, the organic peroxide droplets must be mainly have small average and maximum sizes.

Thus, the peroxide droplets of an organic peroxide emulsion should have a low average size and preferably a homogeneous size distribution, and should be stable over time, preferably over a period of at least three months. In particular, the maximum diameter of these droplets should very preferably not exceed 20 μm.

Moreover, in addition to the safety considerations due to the destabilization phenomenon described above, it is essential to obtain homogeneous emulsions with a small droplet size also for considerations of quality and efficiency of the polymerization process. The reason for this is that the use of a non-homogeneous organic peroxide emulsion or an emulsion with an excessively large droplet size as polymerization initiator in an emulsion or suspension of vinyl monomer may produce inhomogeneity in the final product. This inhomogeneity is generally characterized by polymer particles that are poorly gelled during implementation in molten form (“fish eyes”, hard grains). Now, the presence of hard grains opacifies the polymer material. These stability considerations are thus very important for applications in which the transparency of the final product is imperative, notably for medical applications.

Furthermore, the use of non-homogeneous organic peroxide emulsions, i.e. emulsions having a significant difference in organic peroxide concentration distributed between the upper and lower part of the aqueous phase, can also give rise to unpredictable differences in initiator concentration in the polymerization reactor. A difference in initiator concentration in the polymerization reactor can cause a problem regarding the polymerization time. A concentration that is too low reduces the productivity of the reactor since the polymerization time is extended, and can have an impact on the quality of the polymer. A concentration that is too high causes a very substantial release of energy by the polymerization and thus poses the problem of evacuating this energy. The temperature of the polymerization reactor must then be controlled by the various cooling means, such as the jacket, refrigerated counter-blades or a condenser, or else, if the temperature is not well controlled, the polymerization operation must be stopped.

In addition, the steps of discharging the emulsion in intermediate storage silos, of pumping and of introduction of an organic peroxide emulsion into a polymerization reactor are steps that are important for the quality of the polymer obtained, the reliability of the polymerization process and the productivity. These handling steps must be performed in a short time. To do this, it is important for the peroxide emulsion to have a low viscosity so that the flow of the emulsion is facilitated.

Thus, an organic peroxide emulsion should advantageously have a flowability measured by a consistometric cup technique of less than or equal to 200 seconds (measured, for example, according to the standard DIN 53211, with a viscosity cup diameter of 4 mm and a temperature of 5° C.).

Various organic peroxide emulsions have been developed.

For example, WO 99/31194 describes organic peroxide emulsions comprising an antifreeze and a chlorinated paraffin and optionally nonionic surfactants and protective colloidal agents.

WO 00/42078 relates to peroxide emulsions comprising a copolymer of an α,β-unsaturated dicarboxylic acid and a C8-C24 α-olefin whose acid groups are esterified with an ethoxylated alcohol and also an ethoxylated fatty alcohol with an HLB of greater than 16.

U.S. Pat. No. 5,369,197 describes organic peroxide emulsions comprising a protective colloidal agent, such as a polyvinyl alcohol or xanthan gum and an alcohol, in particular methanol, ethanol or ethylene glycol.

JP H0676445 relates to peroxide emulsions comprising an antifreeze, a nonionic surfactant and/or a protective colloidal agent and alkali metal ions, alkaline-earth metal ions and hydrogen ions.

GB 2083374 relates to aqueous emulsions comprising an organic peroxide, an alcohol with a molecular mass of less than 100 and an emulsifier comprising a polyvinyl alcohol.

FR 2995905 relates to aqueous organic peroxide emulsions not containing a protective colloidal agent, comprising as emulsifier a nonionic surfactant, and also an antifreeze, preferably a mixture of methanol and propane-1,2-diol.

FR 2995906 describes an aqueous organic peroxide emulsion in which the emulsifying agent is a colloidal agent consisting of a polyvinyl acetate having a degree of hydrolysis of greater than 80%.

In the particular case of di-sec-butyl peroxydicarbonate, an additional problem must be taken into account, that of the compatibility of the organic peroxide with the antifreeze.

Indeed, at the present time, the alcohols most commonly used as antifreezes in organic peroxide emulsions are methanol and ethanol. However, it has been found that these alcohols induce phase separation of the emulsion and decomposition of the di-sec-butyl peroxydicarbonate, when they are placed in contact therewith, leading to a deterioration of the emulsion. This incompatibility between di-sec-butyl peroxydicarbonate and methanol and ethanol is specific to this peroxide and is not observed with other peroxides, including other peroxydicarbonates.

In addition, di-sec-butyl peroxydicarbonate has the specificity, relative to other commonly used organic peroxides, of having a density of greater than 1 g/cm³ (at 15° C.). In emulsion, it therefore tends to sediment, unlike other commonly used organic peroxides, which tend to float. Di-sec-butyl peroxydicarbonate thus has a specific behavior in emulsion that is very different from that of other commonly used organic peroxides.

There is thus a real need to provide a di-sec-butyl peroxydicarbonate emulsion which can maintain a low maximum and average droplet size, and which remains stable and homogeneous over a long period of time.

### SUMMARY OF THE INVENTION

The invention relates firstly to an organic peroxide emulsion comprising:
at least one organic peroxide comprising di-sec-butyl peroxydicarbonate;
at least one emulsifier;
at least one antifreeze; and
water;
   said emulsion being free of methanol and ethanol.

In certain embodiments, the at least one antifreeze is an alcohol, preferably chosen from the group consisting of monoalcohols, diols, triols and mixtures thereof.

In certain embodiments, the at least one antifreeze is chosen from the group consisting of ethylene glycol, 2-propanol, 1-propanol, propane-1,2-diol, propane-1,3-diol, glycerol, butan-1-ol, butan-2-ol, butan-1,3-diol, butan-1,4-diol, diethylene glycol, triethylene glycol and mixtures thereof.

In certain embodiments, the at least one antifreeze comprises, preferably consists of, propane-1,2-diol.

In certain embodiments, the at least one antifreeze is present in an amount of from 10% to 40% by weight, preferably from 15% to 25% by weight, relative to the total weight of the emulsion.

In certain embodiments, the at least one organic peroxide consists of di-sec-butyl peroxydicarbonate.

In certain embodiments, the di-sec-butyl peroxydicarbonate is present in an amount of from 30% to 80% by weight, preferably from 40% to 60% by weight, more preferentially from 45% to 60% by weight, relative to the total weight of the emulsion.

In certain embodiments, the at least one emulsifier comprises a nonionic surfactant, preferably chosen from the group consisting of oxyalkylenated fatty alcohols, oxyalkylenated fatty acids, oxyalkylenated plant or animal oils, polysorbates, sorbitan esters, non-oxyalkylenated alkyl glucosides, oxyalkylenated alkyl glucosides and mixtures thereof.

In certain embodiments, the at least one emulsifier comprises at least one protective colloidal agent, preferably at least one polyvinyl alcohol and/or hydrolyzed polyvinyl acetate.

In certain embodiments, the at least one emulsifier consists of at least one protective colloidal agent, preferably at least one polyvinyl alcohol and/or hydrolyzed polyvinyl acetate.

In certain embodiments, the emulsion is free of polyvinyl alcohol and of hydrolyzed polyvinyl acetate.

The invention also relates to a process for preparing an emulsion as described above, comprising the following steps:
mixing the at least one organic peroxide, the at least one emulsifier, the at least one antifreeze and water; and
emulsifying the mixture.

The invention also relates to the use of an emulsion as described above for the polymerization or copolymerization of one or more ethylenically unsaturated monomers, in particular vinyl monomers, preferably halogenated vinyl monomers, and more preferentially vinyl chloride.

The invention also relates to a halogenated vinyl polymer obtained by polymerization of at least one ethylenically unsaturated monomer in the presence of an emulsion as described above.

The present invention meets the need expressed above. More particularly, it provides an emulsion comprising di-sec-butyl peroxydicarbonate which is stable and homogeneous over a long period of time and which retains a small average droplet size and a small maximum droplet size. The emulsion according to the invention can thus be transported and stored over long periods in total safety. In addition, the emulsion according to the invention meets the required conditions in terms of viscosity and flow time. Furthermore, the emulsion according to the invention allows the production of a polymer, when it used for the polymerization of ethylenically unsaturated monomers, having a low content of hard grains.

This is achieved by virtue of the presence, in the emulsion, of an antifreeze combined with the absence of both ethanol and methanol. Indeed, as indicated above, it was found that the presence of methanol or ethanol in a di-sec-butyl peroxydicarbonate emulsion resulted in decomposition of this peroxide and an unstable emulsion. Surprisingly, it was found that emulsions comprising an antifreeze but free of ethanol and methanol remained stable and homogeneous over a long period of time, had a suitable viscosity, and had droplets that remained of small size.

### DETAILED DESCRIPTION

The invention is now described in greater detail and in a nonlimiting manner in the description that follows.

In the present text, unless expressly indicated otherwise, all the percentages (%) shown are percentages by weight.

In the present text, the amounts indicated for a given species may apply to that species according to all its definitions (as mentioned in the present text), including the more restricted definitions.

### Emulsion

The invention relates firstly to an organic peroxide emulsion. The emulsion according to the invention is an aqueous emulsion, i.e. it comprises water. Preferably, the water is demineralized or deionized water.

Particularly preferably, the emulsion is an oil-in-water type emulsion.

The emulsion according to the invention comprises at least one organic peroxide. The at least one organic peroxide comprises di-sec-butyl peroxydicarbonate. This peroxide is sold, for example, under the trade name Luperox® 225 by Arkema.

Advantageously, the at least one organic peroxide may consist of di-sec-butyl peroxydicarbonate. Di-sec-butyl peroxydicarbonate is then the only peroxide in the emulsion.

Alternatively, the at least one peroxide may comprise di-sec-butyl peroxydicarbonate as a mixture with at least a second organic peroxide. The emulsion according to the invention may comprise a mixture of two organic peroxides, or more than two organic peroxides, provided that one of the organic peroxides is di-sec-butyl peroxydicarbonate.

The at least one second peroxide is preferably chosen from peroxydicarbonates, peroxyesters, and/or diacyl peroxides.

Among the peroxydicarbonates, the preferred peroxides are diethyl peroxydicarbonate, diisopropyl peroxydicarbonate, di-n-propyl peroxydicarbonate, di-n-butyl peroxydicarbonate, diisobutyl peroxydicarbonate, di-tert-butyl peroxydicarbonate, bis(3-methoxybutyl) peroxydicarbonate, dineopentyl peroxydicarbonate, bis[2-(2-methoxyethoxy)ethyl] peroxydicarbonate, bis(3-methoxy-3-methylbutyl) peroxydicarbonate, bis(2-ethoxyethyl) peroxydicarbonate, bis(2-ethylhexyl) peroxydicarbonate, and mixtures thereof.

Among the peroxyesters, the preferred peroxides are tert-amyl peroxypivalate, tert-butyl peroxypivalate, tert-butyl peroxyneodecanoate, tert-amyl peroxyneodecanoate, tert-butyl peroxyisobutyrate, cumyl peroxyneodecanoate, cumyl peroxyneoheptanoate, 2,4,4-trimethylpentyl peroxyneodecanoate, tert-butyl peroxy-n-heptanoate, cumyl peroxy-n-heptanoate, tert-amyl peroxy-n-heptanoate, tert-butyl peroxyneoheptanoate, tert-amyl peroxy-2-ethyl hexanoate, tert-butyl peroxy-2-ethylhexanoate, 1,1,3,3-tetramethylbutyl peroxy-2-ethylhexanoate, hydroxyperoxy esters and mixtures thereof.

As hydroxyperoxyesters that may be used in the emulsion according to the invention, mention may be made of 4-hydroxy-2-methylpentyl peroxyneodecanoate, 4-hydroxy-2-methylpentyl peroxy-(2-ethylhexanoate), 4-hydroxy-2-methylpentyl peroxy-2-phenyl butyrate, 4-hydroxy-2-methylpentyl peroxy-2-phenoxypropionate, 4-hydroxy-2-methylpentyl peroxy-(2-butyloctanoate), 4-hydroxy-2-methylpentyl peroxyneotridecanoate, 4-hydroxy-2-methylhexyl peroxyneodecanoate, 5-hydroxy-1,3,3-trimethylcyclohexyl peroxyneodecanoate, 4-hydroxy-2,6-dimethyl-2,6-bis(neohexanoylperoxy)heptane, 4-hydroxy-2,6-dimethyl-2,6-bis(neodecanoylperoxy)heptane, 3-hydroxy-1,1-dimethylbutyl peroxy-2-ethylhexanoate, 3-hydroxy-1,1-dimethylbutyl peroxyneodecanoate and mixtures thereof.

Among the diacyl peroxides, the preferred peroxides are chosen from the group consisting of diisobutyryl peroxide, diheptanoyl peroxide, bis(2-ethylbutanoyl) peroxide, bis(3,5,5-trimethylhexanoyl) peroxide, bis(2-ethylhexanoyl) peroxide, and also asymmetric peroxides such as isobutyroyl octanoyl peroxide, isobutyroyl decanoyl peroxide, isobutyroyl lauroyl peroxide, 2-ethylbutanoyl decanoyl peroxide, 2-ethylhexanoyl lauroyl peroxide, and mixtures thereof.

More preferentially, the second organic peroxide is chosen from the group consisting of tert-butyl peroxyneodecanoate, for example sold under the name Luperox® 10 by Arkema, 3-hydroxy-1,1-dimethylbutyl peroxyneodecanoate, for example sold under the trade name Luperox® 610 by Arkema, cumyl peroxyneodecanoate, for example sold under the name Luperox® 188 by Arkema, bis(2-ethylhexyl) peroxydicarbonate, for example sold under the trade name Luperox® 223 by Arkema, tert-amyl peroxyneodecanoate, for example sold under the name Luperox® 546 by Arkema, tert-butyl peroxypivalate, for example sold under the name Luperox® 11 by Arkema, tert-amyl peroxypivalate, for example sold under the name Luperox® 554 by Arkema, bis(3,5,5-trimethylhexanoyl) peroxide, for example sold under the name Luperox® 219 by Arkema, and mixtures thereof.

When the emulsion comprises more than two peroxides, each of the peroxides other than di-sec-butyl peroxydicarbonate may be as described above.

The second organic peroxide(s) according to the invention advantageously have a one-hour half-life temperature, measured in trichloroethylene, of less than or equal to 90° C., preferably less than 80° C.

Furthermore, the second organic peroxide(s) in the emulsion according to the invention advantageously have a storage temperature below 0° C.

The second organic peroxide(s) are advantageously liquid at the storage temperature, preferably at a storage temperature below 0° C., measured at atmospheric pressure.

Preferably, the emulsion according to the invention comprises the at least one organic peroxide in an amount of from 30% to 80% by weight, preferably from 40% to 60% by weight, more preferentially from 45% to 60% by weight, relative to the total weight of the emulsion. In particular the amount of peroxide, relative to the total weight of the emulsion, may be from 30% to 35% by weight, or from 35% to 40% by weight, or from 40% to 45%, or from 45% to 50%, or from 50% to 55%, or from 55% to 60%, or from 60% to 65%, or from 65% to 70%, or from 70% to 75%, or from 75% to 80% by weight.

Advantageously, di-sec-butyl peroxydicarbonate is present in the emulsion in an amount of from 30% to 80% by weight, preferably from 40% to 60% by weight, more preferentially from 45% to 60% by weight, relative to the total weight of the emulsion. Notably, the amount of di-sec-butyl peroxydicarbonate in the emulsion may be from 30% to 35% by weight, or from 35% to 40% by weight, or from 40% to 45%, or from 45% to 50%, or from 50% to 55%, or from 55% to 60%, or from 60% to 65%, or from 65% to 70%, or from 70% to 75%, or from 75% to 80%, by weight, relative to the total weight of the emulsion.

The emulsion according to the invention comprises at least one antifreeze. The antifreeze prevents the formation of gels when the emulsion is transported and/or stored cold, i.e. conventionally in an environment with temperatures below 0° C.

The antifreeze is preferably an alcohol. Thus, the antifreeze may be any alcohol that is water-soluble at the storage temperature, for example at a temperature of 0° C. The term “water-soluble alcohol” means a solubility of more than 1% in water at 0° C. The amount of antifreeze in water can be measured by gas chromatography.

More particularly, the antifreeze may advantageously be a monoalcohol, a diol and/or a triol.

Preferably, the antifreeze is chosen from the group consisting of ethylene glycol, 2-propanol, 1-propanol, propane-1,2-diol, propane-1,3-diol, glycerol, butan-1-ol, butan-2-ol, butan-1,3-diol, butan-1,4-diol, diethylene glycol, triethylene glycol, and mixtures thereof, these mixtures comprising at least two of the antifreezes listed previously. The mixtures of antifreezes may comprise two or more antifreezes as mentioned above, preferably two.

Particularly advantageously, the antifreeze is propane-1,2-diol, optionally as a mixture with one, or more, antifreezes, preferably as mentioned above. More advantageously, the antifreeze consists of propane-1,2-diol.

The emulsion according to the invention is free of ethanol and free of methanol.

The antifreeze is preferably present in the emulsion according to the invention in a content of less than or equal to 40% by weight (relative to the total weight of the emulsion), preferably less than or equal to 25% by weight, more preferably less than or equal to 22% by weight, relative to the total weight of the emulsion. Such antifreeze contents allow the aqueous phase to remain in liquid form down to temperatures of less than or equal to −20° C., preferably down to temperatures of less than or equal to −25° C.

More particularly, the antifreeze may be present in the emulsion in an amount of from 10% to 40% by weight, preferably from 15% to 25% by weight, relative to the total weight of the emulsion. In certain embodiments, the emulsion comprises from 10% to 15% by weight, or from 15% to 20% by weight, or from 20% to 25% by weight, or from 25% to 30% by weight, or from 30% to 35% by weight, or from 35% to 40% by weight, of antifreeze, relative to the total weight of the emulsion.

The emulsion according to the invention comprises at least one emulsifier.

Preferably, the emulsifier according to the invention is readily biodegradable. The qualification of the biodegradability of the emulsifier may be determined by the OECD 301 method and more particularly by the OECD 301 B method by release of carbon dioxide.

Preferably, the emulsifier comprises, or is (i.e. consists of), a nonionic surfactant. Thus, the emulsion according to the invention may comprise at least one nonionic surfactant.

Even more preferably, the emulsifier comprises, or is, an oxyalkylenated or non-oxyalkylenated nonionic surfactant chosen from the group consisting of fatty alcohols, fatty acids, sorbitan esters, plant or animal oils (hydrogenated or non-hydrogenated), alkyl glucosides and mixtures thereof. The nonionic surfactant mixtures used in the invention may be mixtures of oxyalkylenated nonionic surfactants only, or mixtures of non-oxyalkylenated nonionic surfactants only, or mixtures of oxyalkylenated nonionic surfactants and non-oxyalkylenated nonionic surfactants.

In certain embodiments, the nonionic surfactant may comprise, or be, one or more poly(ethylene oxide) block copolymers and poly(propylene oxide) block copolymers, optionally in combination with one or more other nonionic surfactants, for example as described in the present text.

Advantageously, the emulsifier comprises, or is, a nonionic surfactant chosen from the group consisting of oxyalkylenated fatty alcohols, oxyalkylenated fatty acids, polysorbates, sorbitan esters, oxyalkylenated plant or animal oils, non-oxyalkylenated alkyl glucosides, oxyalkylenated alkyl glucosides, and mixtures thereof.

The oxyalkylene units are more particularly oxyethylene units (i.e. ethylene oxide groups), oxypropylene units (i.e. propylene oxide groups), or a combination of oxyethylene units and oxypropylene units; preferably, the oxyalkylene units are oxyethylene units or a combination of oxyethylene units and oxypropylene units.

Thus, the nonionic surfactant is preferably chosen from the group consisting of fatty alcohols containing oxyethylene units and optionally oxypropylene units, fatty acids containing oxyethylene units and optionally oxypropylene units, polysorbates, sorbitan esters, plant or animal oils, which are optionally hydrogenated, containing oxyethylene units and optionally oxypropylene units, alkyl glucosides containing oxyethylene units and optionally oxypropylene units, and mixtures thereof.

The oxyethylene units (i.e. ethylene oxide groups) and oxypropylene units (i.e. propylene oxide groups) may be randomly distributed or in block form.

The number of moles of ethylene oxide and/or propylene oxide preferably ranges from 1 to 250, more preferentially from 2 to 100, even more preferentially from 2 to 50 and more particularly from 2 to 20.

Preferably, the number of moles of ethylene oxide in the emulsifier ranges from 2 to 20.

For the purposes of the present invention, the term “fatty alcohol” means an alcohol containing at least 6, preferably at least 8, carbon atoms, more preferably a C₈-C₄₀ alcohol, preferentially a C₈-C₂₀ alcohol.

Among the fatty alcohols that may be used in the invention, mention may notably be made of 2-octyldodecanol, decanol, lauryl alcohol, oleocetyl alcohol, isodecanol, capryl alcohol, oxoisotridecanol, cetostearyl alcohol, eleostearyl alcohol, caprylyl alcohol, myristyl alcohol, hexadecyl or palmityl alcohol, stearyl alcohol, eicosanyl or arachidyl alcohol, behenyl alcohol, oleyl alcohol, eicosenyl or gadoleyl alcohol, docosenyl alcohol, ricinoleyl alcohol, linoleyl alcohol, linolenyl alcohol or mixtures thereof.

Preferably, the nonionic surfactant is chosen from the group consisting of oxyalkylenated fatty alcohols and is preferably chosen from octyldodecanol, decanol, lauryl alcohol, oleocetyl alcohol, isodecanol, capryl alcohol, oxoisotridecanol, cetostearyl alcohol, eleostearyl alcohol, caprylyl alcohol, myristyl alcohol, hexadecyl or palmityl alcohol, stearyl alcohol, eicosanyl or arachidyl alcohol, behenyl alcohol, oleyl alcohol, eicosenyl or gadoleyl alcohol, docosenyl alcohol, ricinoleyl alcohol, linoleyl alcohol or linolenyl alcohol, which are oxyalkylenated, preferably oxyethylenated and/or oxypropylenated, and more preferentially oxyethylenated and optionally oxypropylenated.

The fatty alcohols that are more preferred in the context of the invention are oleocetyl alcohol, hexadecyl or palmityl alcohol, stearyl alcohol, oleyl alcohol, linoleyl alcohol or mixtures thereof, and even more preferred are the oxyalkylenated, preferably oxyethylenated and/or oxypropylenated, and more preferably oxyethylenated and optionally oxypropylenated versions thereof.

More preferably, the nonionic surfactant is an oxyalkylenated fatty alcohol chosen from the group consisting of oxyethylenated linoleyl alcohol, oxyethylenated oleocetyl alcohol, oxyethylenated hexadecyl or palmityl alcohol, oxyethylenated stearyl alcohol, oxyethylenated oleyl alcohol, and mixtures thereof.

The abovementioned fatty alcohols may optionally be oxypropylenated to a minor extent.

Preferably, the oxyalkylenated plant/animal oils (hydrogenated or non-hydrogenated) are in particular derivatives of ethoxylated mono-, di- and triglycerides and comprise a complex mixture of ethoxylated glycerol optionally linked to one or more fatty acid chains (which are themselves ethoxylated or not), fatty acids ethoxylated on the acid function and/or on the hydroxyl function borne the fatty acid chain, and also variable proportions of fatty acids, glycerol and fatty acid mono-, di- or triglycerides.

For the purposes of the present invention, the term “fatty acid” means an acid or a mixture of acids comprising at least 6 carbon atoms, preferably from 6 to 40 carbon atoms, more preferentially from 8 to 20 carbon atoms.

The oxyalkylenated plant/animal oils (hydrogenated or non-hydrogenated) that may be used in the invention are preferably chosen from the group consisting of optionally hydrogenated, oxyethylenated (or ethoxylated) plant oils.

The optionally hydrogenated, oxyethylenated plant oils are preferably chosen from the group consisting of ethoxylated castor oil and ethoxylated hydrogenated castor oil comprising from 5 to 40 mol of ethylene oxide per mole of ricinoleic acid. Mention may also be made of ethoxylated oils derived from coconut kernel oil, palm oil, palm kernel oil, olive oil, groundnut oil, rapeseed oil, soybean oil, sunflower oil, walnut oil, hazelnut oil, coconut oil, poppy oil, safflower oil, linseed oil, perilla oil, oitica oil, and/or Chinese wood oil.

As plant/animal oils that may be used according to the invention as emulsifiers, mention may also be made of ethoxylated fats based on tallow oil, crude or refined tall oil, whale oil, herring oil and/or sardine oil. All these ethoxylated glyceride derivatives are characterized in that they include mixtures of ethoxylated mono-, di- or triglycerides and also corresponding ethoxylated derivatives of fatty acids and of glycerol. These fatty acids are notably saturated or unsaturated fatty acids derived from caproic acid, caprylic acid, capric acid, lauric acid, myristic acid, palmitic acid, stearic acid, arachic acid, behenic acid, myristoleic acid, palmitoleic acid, oleic acid, ricinoleic acid, erucic acid, linoleic acid, linolenic acid, eleostearic acid, licanic acid, gadoleic acid, and/or erneic acid. Some unsaturated fatty acids may or may not be hydrogenated as in the case of ethoxylated castor oil in which the ricinoleic group may or may not have been partially or fully hydrogenated.

In certain embodiments, the emulsifier according to the invention may comprise, or be, one or more fatty acids, which are preferably oxyalkylenated, more preferably oxyethylenated and optionally oxypropylenated, these fatty acids being selectable from those listed above.

Advantageously, the emulsifier may comprise, or be, a nonionic surfactant chosen from the group consisting of oxyalkylenated plant or animal oils (hydrogenated or non-hydrogenated).

More preferentially, the emulsifier may comprise, or be, a nonionic surfactant chosen from the group consisting of plant oils, which are optionally hydrogenated, oxyethylenated and optionally oxypropylenated.

More preferentially, the emulsifier may comprise, or be, a nonionic surfactant chosen from the group consisting of ethoxylated, optionally hydrogenated plant oils including from 5 to 40 mol of ethylene oxide, in particular ethoxylated castor oil and ethoxylated hydrogenated castor oil including from 20 to 40 mol of ethylene oxide.

Even more preferentially, the emulsifier may comprise, or be, ethoxylated castor oil including from 20 to 40 mol of ethylene oxide.

Advantageously, the emulsifier may comprise, or be, one or more non-ethoxylated sorbitan esters and/or one or more ethoxylated sorbitan esters. In the present text, ethoxylated sorbitan esters are also referred to as “polysorbates”, the term “sorbitan ester” denoting in the present text non-ethoxylated sorbitan esters, unless expressly indicated otherwise.

Preferably, the non-ethoxylated sorbitan ester is chosen from the group consisting of sorbitan monostearate, sorbitan tristearate, sorbitan monolaurate, sorbitan trilaurate, sorbitan monooleate, sorbitan trioleate, sorbitan monopalmitate and sorbitan tripalmitate and combinations thereof.

Sorbitan monooleate is available under the brand name Span 80® (from Croda).

Preferably, the ethoxylated sorbitan ester (or polysorbate) comprises between 3 and 40 ethylene oxide groups, preferably between 5 and 20 ethylene oxide groups.

Preferably, the ethoxylated sorbitan ester is chosen from the group consisting of ethoxylated sorbitan monostearate, ethoxylated sorbitan tristearate, ethoxylated sorbitan monolaurate, ethoxylated sorbitan trilaurate, ethoxylated sorbitan monooleate, ethoxylated sorbitan trioleate, ethoxylated sorbitan monopalmitate, ethoxylated sorbitan tripalmitate and combinations thereof.

Sorbitan monooleate 20 OE (i.e. containing 20 ethylene oxide groups) is available under the brand name Surfaline SE80® (from Arkema) or Tween 80® (from Croda).

The emulsifier may comprise, or be, one or more alkyl glucosides. As alkyl glucosides that may be used in the invention, mention may be made of capryl glucoside, caprylyl glucoside, lauryl glucoside, cocoyl glucoside, hexyl glucoside, isooctyl glucoside, decyl glucoside and/or undecyl glucoside. These alkyl glucosides may or may not be oxyalkylenated (and more particularly ethoxylated or non-ethoxylated).

The emulsion may comprise a combination of at least two emulsifiers, in particular each of which may independently be as described above.

Preferably, the combination of the at least two emulsifiers comprises a non-ethoxylated sorbitan as defined above and an ethoxylated sorbitan comprising between 5 and 20 ethylene oxide groups, as described above.

In addition or as an alternative to the use of one or more nonionic surfactants (for example as described above), the emulsion according to the invention may comprise, as emulsifier, at least one protective colloidal agent. Protective colloidal agents are emulsifiers that are well known to those skilled in the art. For the purposes of the present invention, they refer to the group consisting of polyvinyl alcohol, polyvinyl acetate and notably partially hydrolyzed polyvinyl acetate, cellulose esters and xanthan gums.

Thus, preferably, the protective colloidal agent in the emulsion according to the invention is chosen from the group consisting of polyvinyl alcohols, partially hydrolyzed polyvinyl acetates, cellulose esters, xanthan gums and mixtures thereof. The hydrolyzed polyvinyl acetate is preferably hydrolyzed to a degree of from 5 mol % to 85 mol %, preferably from 5 mol % to 75 mol %.

The at least one emulsifier of the emulsion according to the invention may consist of at least one protective colloidal agent.

More particularly, the emulsion according to the invention may comprise, as the at least one emulsifier, at least one polyvinyl alcohol and/or at least one hydrolyzed polyvinyl acetate, optionally in combination with one or more surfactants, in particular one or more nonionic surfactants as described above. The at least one emulsifier of the emulsion according to the invention may consist of at least one polyvinyl alcohol and/or at least one hydrolyzed polyvinyl acetate, optionally in combination with one or more surfactants, in particular one or more nonionic surfactants as described above.

The emulsifier according to the invention may consist of at least one nonionic surfactant, in particular at least one nonionic surfactant as described above, and optionally at least one protective colloidal agent.

The emulsifier according to the invention may consist of at least one protective colloidal agent and optionally at least one nonionic surfactant, in particular at least one nonionic surfactant as described above.

Alternatively, the emulsion according to the invention may be free of polyvinyl alcohol. The emulsion according to the invention may be free of partially hydrolyzed polyvinyl acetate, and may more particularly be free of polyvinyl acetate.

More particularly, the emulsion according to the invention may be free of protective colloidal agent. This notably makes it possible to reduce the time for the industrial preparation of the emulsion, since the protective colloidal agent (notably polyvinyl acetate) which is in solid form requires a prior dissolution step, and makes it possible to minimize the risks associated with the handling of powders. Furthermore, the presence in the emulsion of a colloidal protective agent may increase the viscosity of the emulsion, which may be undesirable for certain applications.

The emulsion according to the invention may be free of cellulose ester, more particularly cellulose derivatives. The emulsion may be free of xanthan gum.

The emulsifier may be present in the emulsion according to the invention in an amount ranging from 0.1% to 10% by weight, preferably from 0.5% to 5% by weight, relative to the total weight of the emulsion. In particular, the emulsion may comprise the emulsifier in an amount of from 0.1% to 0.5% by weight, or from 0.5% to 1% by weight, or from 1% to 2% by weight, or from 2% to 3% by weight, or from 3% to 4% by weight, or from 4% to 5% by weight, or from 5% to 6% by weight, or from 6% to 7% by weight, or from 7% to 8% by weight, or from 8% to 9% by weight, or from 9% to 10% by weight, relative to the total weight of the emulsion.

The emulsion according to the invention may comprise the at least one nonionic surfactant in an amount of from 0.1% to 10% by weight, preferably from 0.5% to 5% by weight, relative to the total weight of the emulsion. In particular, the emulsion may comprise the nonionic surfactant in an amount of from 0.1% to 0.5% by weight, or from 0.5% to 1% by weight, or from 1% to 2% by weight, or from 2% to 3% by weight, or from 3% to 4% by weight, or from 4% to 5% by weight, or from 5% to 6% by weight, or from 6% to 7% by weight, or from 7% to 8% by weight, or from 8% to 9% by weight, or from 9% to 10% by weight, relative to the total weight of the emulsion.

The emulsion according to the invention may comprise the at least one protective colloidal agent in an amount of from 0.1% to 10% by weight, preferably from 0.5% to 5% by weight, relative to the total weight of the emulsion. In particular, the emulsion may comprise the nonionic surfactant in an amount of from 0.1% to 0.5% by weight, or from 0.5% to 1% by weight, or from 1% to 2% by weight, or from 2% to 3% by weight, or from 3% to 4% by weight, or from 4% to 5% by weight, or from 5% to 6% by weight, or from 6% to 7% by weight, or from 7% to 8% by weight, or from 8% to 9% by weight, or from 9% to 10% by weight, relative to the total weight of the emulsion.

The emulsion according to the invention may also comprise one or more additives intended to give the final composition particular properties/characteristics. These additives will ideally be present for the final polymerization or copolymerization.

The additive may be chosen from the group consisting of antifoams, chain-transfer agents, chain extenders, pH regulators, plasticizers and mixtures thereof.

The additive(s) are preferably in an amount of from 0.1% to 10% by weight, preferably from 1% to 5% by weight, relative to the total weight of the emulsion.

Preferably, the emulsion according to the invention comprises one or more plasticizers, preferably chosen from the group consisting of aliphatic esters, for instance phthalates, adipates, benzoates, hydrogenated derivatives of these molecules and mixtures thereof. In particular, the plasticizer may be diisononylcyclohexane, diisononyl cyclohexanedicarboxylate, and a mixture thereof. The plasticizer(s) may be present in the emulsion in an amount of from 1% to 5% by weight relative to the total weight of the emulsion.

Advantageously, the emulsion according to the invention may consist essentially of, or consist of, the at least one organic peroxide, the at least one emulsifier, the at least one antifreeze, water and optionally one or more additives as described above. The term “the emulsion consists essentially of constituents” means that the total amount of these constituents represents at least 90% by weight, preferably at least 95% by weight, more preferentially at least 98% by weight of the total weight of the emulsion. The expression “consists of” does not exclude the presence of impurities present in trace amounts in the emulsion (for example, in an amount of less than or equal to 1% by weight relative to the total weight of the emulsion), for example impurities introduced with the organic peroxide. Thus, in certain embodiments, the emulsion according to the invention may comprise an organic solvent, in an amount of less than or equal to 1% by weight relative to the total weight of the emulsion.

In other embodiments, the emulsion according to the invention may comprise an organic solvent, for example in an amount of less than or equal to 20% by weight relative to the total weight of the emulsion. In the present text, the term “organic solvent” means organic solvents which have a solubility in water of less than 1% by weight at 0° C. The emulsion according to the invention may consist essentially of, or consist of, the at least one organic peroxide, the at least one emulsifier, the at least one antifreeze, water, an organic solvent (preferably in an amount of less than or equal to 20% by weight relative to the total weight of the emulsion) and optionally one or more additives as described above.

The emulsion according to the invention may consist essentially of, or consist of, the at least one organic peroxide, the at least one emulsifier, the at least one antifreeze and water (the emulsion being free of methanol and ethanol).

Preferably, the emulsion according to the invention has a flowability (or flow time) at 5° C., measured via a consistometric cup technique, of less than or equal to 200 seconds, more preferentially less than or equal to 150 seconds, and even more advantageously less than or equal to 100 seconds. The flowability may be measured according to the standard DIN 53211, with a viscosity cup diameter of 4 mm and a temperature of 5° C.

Particularly advantageously, the emulsion according to the invention has an average droplet size of less than or equal to 10 μm, preferably less than or equal to 7 μm and more particularly advantageously less than or equal to 6 μm. Advantageously, the emulsion according to the invention has a maximum droplet size of less than or equal to 20 μm, more preferentially less than or equal to 18 μm, and even more advantageously less than or equal to 15 μm. The droplet size (average and maximum) may be determined via conventional means using the light scattering technique. The measurements may be taken using a Malvern Master Sizer 2000® device at room temperature.

More advantageously, the emulsion according to the invention has the abovementioned droplet sizes during the storage period, for example for a period of at least three months.

Preferably, the concentration of organic peroxide in the emulsion is homogeneous. The term “homogeneous concentration” means that the difference between the concentrations of peroxide (as mass percentages) at the top and bottom of the emulsion is less than 3%. The organic peroxide concentration is measured by HPLC on a sample taken from the top of the emulsion and another from the bottom of the emulsion.

More advantageously, the emulsion according to the invention is homogeneous during the storage period, for example for a period of at least three months.

### Preparation of the Emulsion

The invention also relates to a process for preparing the emulsion according to the invention.

The preparation process according to the invention comprises a step of mixing the at least one organic peroxide, the at least one emulsifier, the at least one antifreeze and water. This step may also comprise the above mixing with other constituents of the emulsion when the emulsion comprises them, for example mixing with one or more additives (such as one or more plasticizers, etc.) as described in the previous section. The mixing may be performed in one step (the constituents all being added to the mixture simultaneously) or in several steps (a premix of some constituents first being made, followed by the addition of other constituents).

The process also comprises a step of emulsifying the mixture. The steps of mixing of the constituents of the emulsion and of emulsifying may be simultaneous. Alternatively, the emulsifying step may be performed successively to a first step of mixing the constituents of the emulsion.

The emulsion according to the invention may be prepared by dispersing at least the emulsifier and the antifreeze, and also optionally one or more additives, in water so as to obtain a homogeneous aqueous phase, then by adding one or more organic peroxides to said aqueous phase, the whole being then emulsified in the course of an emulsification step at a temperature preferably below 5° C., so as to limit premature degradation of the peroxide, and more preferably below −5° C. Alternatively, the emulsifier or one or more of the emulsifiers may be dissolved in the organic peroxide(s) before being added to the aqueous phase.

The abovementioned steps may be performed in the particular order indicated above, or in a different order.

The temperature at which the emulsion is prepared is not critical, but it must be sufficiently low to avoid a high rate of decomposition of the organic peroxide, which would result in a loss of titer. The temperature chosen depends on the organic peroxide. It is, for example, between 15 and 10° C., preferably from −10 to 5° C. Preferably, the mixing and emulsifying steps are performed at the same temperature, preferably within the ranges mentioned above.

Deionized water or distilled water is preferably used to prepare the aqueous emulsion.

The emulsifying step of the process according to the invention is preferably performed with a high-shear mixer to optimally divide and/or homogenize the peroxide in the aqueous phase. Examples that may be mentioned include mechanically rotating blade and anchor agitators, impeller agitators, i.e. one or more agitators mounted on a common shaft, turbine agitators, i.e. those including baffles attached to the mixing vessel or adjacent to the agitator members. Colloidal mills and homogenizers may also be used.

According to one variant of the process according to the invention, an ultrasonic mixer or a rotor-stator mixer may be used for the emulsification.

Following the preparation of the emulsion, the steps of pumping and introducing the emulsions into a polymerization reactor should generally be performed as quickly as possible. Accordingly, the peroxide emulsions should advantageously have a low viscosity. Thus, the organic peroxide emulsions according to the invention preferably have a dynamic viscosity range, at −10° C. and at a shear rate of 100 s⁻¹, of less than or equal to 850 mPa·s, more preferably less than or equal to 700 mPa·s, more preferentially less than or equal to 500 mPa·s, immediately after production (the viscosities are measured, for example, according to the standard DIN 53019 with apparatus of the Haake VT550 Viscotester type, at −10° C. and for a shear rate of 100 s⁻¹).

Their flowability, measured by means of a consistometric cup technique, is advantageously less than or equal to 200 seconds, more preferentially less than or equal to 170 seconds, and even more advantageously less than or equal to 100 seconds (measured, for example, according to the standard DIN 53211, with a viscosity cup diameter of 4 mm and a temperature of 5° C.).

The average droplet size of the emulsion is preferably less than or equal to 10 μm, more preferably less than or equal to 7 μm and more particularly advantageously less than or equal to 6 μm. Advantageously, the maximum droplet size of the emulsion is less than or equal to 20 μm, more preferentially less than or equal to 18 μm, and even more advantageously less than or equal to 15 μm. The droplet size (average and maximum) may be determined via conventional means using the light scattering technique and the measurements may be taken using a Malvern Master Sizer 2000® device at room temperature.

### Use

The present invention also relates to the use of the emulsion as described above for the polymerization or copolymerization of one or more ethylenically unsaturated monomers, in particular of one or more vinyl monomers, preferably halogenated vinyl monomers, and more preferentially vinyl chloride.

As examples of ethylenically unsaturated monomers that may be used in the invention, mention may be made of acrylates, vinyl esters, vinyl halide monomers, vinyl ethers, butadiene and/or aromatic vinyl compounds such as styrene.

Preferably, the ethylenically unsaturated monomers are chosen from the group consisting of vinyl halide monomers (i.e. halogenated vinyl monomers), and more preferentially the ethylenically unsaturated monomers are vinyl chloride.

The invention also relates to a process for preparing a halogenated vinyl polymer, comprising a step of polymerization or copolymerization of one or more ethylenically unsaturated monomers in the presence of an emulsion as described above. The ethylenically unsaturated monomers may be as described above and are more preferentially vinyl chloride. The halogenated vinyl polymer prepared is preferably a poly(vinyl chloride).

The polymerization of the ethylenically unsaturated monomer(s), preferably the polymerization of the vinyl chloride monomer, advantageously takes place in suspension, preferably at an initiation temperature ranging from 45° C. to 70° C.

The emulsion may be added directly to the polymerization reactor or may be premixed with other organic peroxides, water, polyvinyl alcohol and/or other additives prior to introducing this mixture into the polymerization reactor.

### Polymer

Another subject of the present invention relates to a halogenated vinyl polymer obtained (or which may be obtained) by polymerization of at least one ethylenically unsaturated monomer, as described above, in the presence of the emulsion according to the invention as described above. The polymerization may be as described in the preceding section.

Preferably, the invention relates to a poly(vinyl chloride) obtained (or which may be obtained) by polymerization of vinyl chloride in the presence of the emulsion according to the invention.

The invention also relates to a halogenated vinyl polymer obtained (or which may be obtained) via a preparation process as described above.

Such halogenated vinyl polymers have the advantage of having a low hard grain content. The hard grain content may be determined as described in the article by O. Leachs, in Kunststoffe, Vol. 50(4), 1960 pages 227-234.

### EXAMPLES

The examples that follow illustrate the invention without limiting it.

The following emulsions were prepared (the amounts indicated in the tables below are expressed as mass percentages relative to the total weight of the emulsion):

TABLE 1

| Composition | | | | | |
|---|---|---|---|---|---|
| No. | 1 | 2 | 3 | 4 | 5 |
| PVA | 1.2 | 1.2 | 1.9 | 1.9 | 1.9 |
| Methanol | 11.3 | | 9.9 | | 9.4 |
| Ethanol | | 11.3 | | 9.3 | |
| Propane-1,2-diol | 3.2 | 3.3 | 6.5 | 6.9 | 6.5 |
| Luperox 225 | 60.0 | 59.7 | 59.6 | 59.7 | 50.2 |
| Demineralized | qs 100 | qs 100 | qs 100 | qs 100 | qs 100 |
| water | | | | | |

TABLE 2

| Composition | | | | | |
|---|---|---|---|---|---|
| No. | 6 | 7 | 8 | 9 | 10 |
| PVA | 1.9 | 1.2 | 1.2 | | |
| Surfaline LG15 | | | | 1.6 | 1.5 |
| Ethanol | 9.3 | | | | 13.5 |
| Propane-1,2-diol | 6.5 | 21.6 | 21.4 | 21.4 | 6.6 |
| Luperox 225 | 50.2 | 49.8 | 50.1 | 50.1 | 50.1 |
| Demineralized | qs 100 | qs 100 | qs 100 | qs 100 | qs 100 |
| water | | | | | |

qs 100 = quantity sufficient to reach 100% of the weight of the emulsion.

The nature of the compounds used is indicated below:
Luperox 225: di-sec-butyl peroxydicarbonate;
Surfaline LG15: nonionic surfactant, unsaturated C₁₆-018 and 018 glycerol mono-/diester, polyethoxylated (15 units);
PVA: polyvinyl acetate with a degree of hydrolysis of 72.5 mol % (Alcotex 72.5).

Emulsions 7, 8 and 9 correspond to emulsions according to the invention, and emulsions 1, 2, 3, 4, 5, 6 and 10 are comparative emulsions.

The emulsions were prepared as described below.

The aqueous phase containing the emulsifier, antifreeze and water was stirred at between 500 and 1000 revolutions per minute (rpm) and maintained at −5° C. (Celsius).

The organic peroxides were added gradually to the reactor containing this mixture. Stirring was continued for three minutes at 2000 rpm. The whole was then stirred vigorously with an “Ultra-Turrax S-25N 18G” blender for two minutes (except for emulsion No. 8, which was stirred for six minutes) at 9500 rpm, then stirred with a paddle at 1000 rpm for one minute. Each emulsification is made on 200 g in total.

The emulsions were then transferred into a plastic container, the container was closed and the emulsions were stored at −20° C. for the time indicated.

The flow time at 5° C. (viscosity cup at 5° C.), the average and maximum droplet sizes, by volume, over a period of 6 months, and also the concentration of organic peroxide at the top and bottom of the aqueous phase of the emulsion (as weight percentages relative to the total weight of the aqueous phase) were determined, as indicated below.

The flow time measurements are taken using consistometric cups according to the standard DIN 53211 (viscosity cup diameter: 4 mm), which is well known to those skilled in the art. The measurement is taken on 100 g of emulsion after conditioning at +5° C. The flow time measurements are expressed in seconds and the accuracy is ±10% of the indicated value.

The average droplet size and the maximum droplet size are determined via conventional means using the light scattering technique. The measurements are taken using a Malvern Mastersizer 2000® device at room temperature. The average droplet size and the maximum droplet size are given with an accuracy of ±0.5 μm (micrometer).

After 6 months of storage at −20° C., a sample from the top of the emulsion (taken from the first centimeter below the emulsion surface) and a sample from the bottom of the emulsion (taken from the first centimeter from the bottom of the emulsion) were taken and analyzed to determine the organic peroxide concentration. The concentrations of organic peroxide in the aqueous phase were determined on a Waters H-class UPLC machine with an accuracy of ±1%.

The results are presented in the tables below.

TABLE 3

| Composi- | | | | | |
|---|---|---|---|---|---|
| tion No. | 1 | 2 | 3 | 4 | 5 |

After preparation of the emulsion (T₀)

| | | | | | |
|---|---|---|---|---|---|
| Viscosity | 108 | 142 | 262 | 290 | 48 |
| cup at | | | | | |
| 5° C. (s) | | | | | |
| Average | 3.3 | 2.4 | 2.5 | 2.4 | 2.9 |
| droplet size | | | | | |
| (μm) | | | | | |
| Maximum | 8.7 | 15.1 | 6.6 | 15.1 | 7.6 |
| droplet size | | | | | |
| (μm) | | | | | |

At T₀ + 1 month

| | | | | | |
|---|---|---|---|---|---|
| Average | Not | 7.6 | 10.4 | 9.1 | Not |
| droplet size | measurable | | | | measurable |
| (μm) | due to | | | | due to |
| Maximum | demixing, | 26.3 | 34.7 | 26.3 | demixing, |
| droplet size | appearance | | | | appearance |
| (μm) | of | | | | of |
| | pressure in | | | | pressure in |
| | the | | | | the |
| | container | | | | container |

At T₀ + 2 months

| | | | | | |
|---|---|---|---|---|---|
| Average | Not | Not | Not | Not | Not |
| droplet size | measurable | measurable | measurable | measurable | measurable |
| (μm) | due to | due to | due to | due to | due to |
| Maximum | demixing | demixing, | demixing, | demixing, | demixing |
| droplet size | | appearance | appearance | appearance | |
| (μm) | | of | of | of | |
| | | pressure in | pressure in | pressure in | |
| | | the | the | the | |
| | | container | container | container | |

TABLE 41

| Composi- | | | | | |
|---|---|---|---|---|---|
| tion No. | 6 | 7 | 8 | 9 | 10 |

After preparation of the emulsion (T₀)

| | | | | | |
|---|---|---|---|---|---|
| Viscosity | 57 | 100 | 90 | 23 | Not |
| cup at | | | | | measurable |
| 5° C. (s) | | | | | due to |
| Average | 2 | 2.5 | 1.9 | 2.1 | demixing |
| droplet size | | | | | after a |
| (μm) | | | | | period of |
| Maximum | 5.8 | 6.6 | 5.8 | 5.8 | about 2 |
| droplet size | | | | | hours |
| (μm) | | | | | |

At T₀ + 1 month

| | | | | | |
|---|---|---|---|---|---|
| Average | Not | Not | Not | 2.1 | Not |
| droplet size | measurable | measured | measured | | measurable |
| (μm) | due to | | | | due to |
| Maximum | demixing, | | | 5.8 | demixing |
| droplet size | appearance | | | | |
| (μm) | of | | | | |
| | pressure | | | | |
| | in the | | | | |
| | container | | | | |

At T₀ + 2 months

| | | | | | |
|---|---|---|---|---|---|
| Average | Not | 5.2 | 3.2 | 2.2 | Not |
| droplet size | measurable | | | | measurable |
| (μm) | due to | | | | due to |
| Maximum | demixing | 13.2 | 15.1 | 5.8 | demixing |
| droplet size | | | | | |
| (μm) | | | | | |

At T₀ + 3 months

| | | | | | |
|---|---|---|---|---|---|
| Average | Not | 5.9 | 5.8 | 2.2 | Not |
| droplet size | measurable | | | | measurable |
| (μm) | due to | | | | due to |
| Maximum | demixing | 15.1 | 15.1 | 6.6 | demixing |
| droplet size | | | | | |
| (μm) | | | | | |

At T₀ + 4 months

| | | | | | |
|---|---|---|---|---|---|
| Average | Not | 6.3 | 6.2 | 2.2 | Not |
| droplet size | measurable | | | | measurable |
| (μm) | due to | | | | due to |
| Maximum | demixing | 17.4 | 17.4 | 6.6 | demixing |
| droplet size | | | | | |
| (μm) | | | | | |

At T₀ + 5 months

| | | | | | |
|---|---|---|---|---|---|
| Average | Not | 6.6 | 6.6 | 2.2 | Not |
| droplet size | measurable | | | | measurable |
| (μm) | due to | | | | due to |
| Maximum | demixing | 17.4 | 17.4 | 6.6 | demixing |
| droplet size | | | | | |
| (μm) | | | | | |

At T₀ + 6 months

| | | | | | |
|---|---|---|---|---|---|
| Average | Not | 7.2 | 6.9 | 2.2 | Not |
| droplet size | measurable | | | | measurable |
| (μm) | due to | | | | due to |
| Maximum | demixing | 20.0 | 20.0 | 6.6 | demixing |
| droplet size | | | | | |
| (μm) | | | | | |
| Concen- | | 47.70% | 48.30% | 48.90% | |
| tration at | | | | | |
| the top | | | | | |
| (%) | | | | | |
| Concen- | | 49.60% | 50.30% | 49.10% | |
| tration | | | | | |
| at the | | | | | |
| bottom | | | | | |
| (%) | | | | | |

It is seen that emulsions 7 and 8 according to the invention are more stable than emulsions 1 to 6. Indeed, the latter undergo demixing after only 1 or 2 months of storage, whereas emulsions 7 and 8 remain stable over a period of at least 6 months. The appearance of pressure in the container of emulsions 1 to 6 is also observed, which is a sign of decomposition of the Luperox 225. In addition, the average droplet size of emulsions 7 and 8 remains small over a period of at least 6 months. Furthermore, after 6 months, the concentrations of organic peroxide at the top and bottom of the aqueous phase of emulsions 7 and 8 are similar: emulsions 7 and 8 are still homogeneous after 6 months of storage.

Emulsion 9 according to the invention is also more stable than the comparative emulsion 10, for which phase separation is observed as early as 2 hours after its preparation. On the other hand, emulsion 9 according to the invention maintains its stability over a period of at least 6 months and retains a low average and maximum droplet size over this period. In addition, after 6 months, emulsion 9 has remained homogeneous, the concentrations of organic peroxide at the top and bottom of the aqueous phase being similar.

The viscosity cup values of the emulsions according to the invention are relatively low and are suitable for a polymerization application.

1-14. (canceled)

15. An organic peroxide emulsion comprising:
at least one organic peroxide comprising di-sec-butyl peroxydicarbonate;
at least one emulsifier;
at least one antifreeze; and
water;
said emulsion being free of methanol and ethanol.

16. The emulsion as claimed in claim 15, in which the at least one antifreeze is an alcohol.

17. The emulsion as claimed in claim 15, in which the at least one antifreeze is chosen from the group consisting of ethylene glycol, 2-propanol, 1-propanol, propane-1,2-diol, propane-1,3-diol, glycerol, butan-1-ol, butan-2-ol, butan-1,3-diol, butan-1,4-diol, diethylene glycol, triethylene glycol and mixtures thereof.

18. The emulsion as claimed in claim 15, in which the at least one antifreeze comprises propane-1,2-diol.

19. The emulsion as claimed in claim 15, in which the at least one antifreeze is present in an amount of from 10% to 40% by weight relative to the total weight of the emulsion.

20. The emulsion as claimed in claim 15, in which the at least one organic peroxide consists of di-sec-butyl peroxydicarbonate.

21. The emulsion as claimed in claim 15, in which the di-sec-butyl peroxydicarbonate is present in an amount of from 30% to 80% by weight relative to the total weight of the emulsion.

22. The emulsion as claimed in claim 15, in which the at least one emulsifier comprises a nonionic surfactant.

23. The emulsion as claimed in claim 15, in which the at least one emulsifier comprises at least one protective colloidal agent.

24. The emulsion as claimed in claim 15, wherein the at least one protective colloidal agent comprises at least one polyvinyl alcohol and/or hydrolyzed polyvinyl acetate.

25. The emulsion as claimed in claim 15, which is free of polyvinyl alcohol and of hydrolyzed polyvinyl acetate.

26. A process for preparing the emulsion as claimed in claim 15, comprising the following steps:
mixing the at least one organic peroxide, the at least one emulsifier, the at least one antifreeze and water; and
emulsifying the mixture.

27. A process for the polymerization or copolymerization of one or more ethylenically unsaturated monomers comprising contacting the emulsion as claimed in claim 15 with the one or more ethylenically unsaturated monomers.

28. A halogenated vinyl polymer obtained by polymerization of at least one ethylenically unsaturated monomer in the presence of the emulsion as claimed in claim 15.

29. The emulsion as claimed in claim 16, in which the at least one antifreeze is chosen from the group consisting of monoalcohols, diols, triols and mixtures thereof.

30. The emulsion as claimed in claim 22, in which the nonionic surfactant is chosen from the group consisting of oxyalkylenated fatty alcohols, oxyalkylenated fatty acids, oxyalkylenated plant or animal oils, polysorbates, sorbitan esters, non-oxyalkylenated alkyl glucosides, oxyalkylenated alkyl glucosides and mixtures thereof.
